(19) United States
(12) Patent Application Publication
(10) Pub. No.: US 2006/0021401 A1
(43) Pub. Date: Feb. 2, 2006

(54) TUBULAR LOCK HAVING TWO-STAGE OPERABLE LATCH BOLT MECHANISM

(76) Inventor: Ching-He Sh, Hualien Hsien (TW)

Correspondence Address: BIRCH STEWART KOLASCH & BIRCH, PO BOX 747, FALLS CHURCH, VA, 22040-0747, US

(21) Appl. No.: 10/902,080

(22) Filed: Jul. 30, 2004

(51) Int. Cl. E05B 13/10

(52) U.S. Cl. 70/224

(57) ABSTRACT

Disclosed is a tubular lock. The lock comprises an inside knob, an outside knob, and a two-stage latch bolt mechanism interconnecting the inside and outside knobs. Using a key to insert a spindle into a cam, and turning the spindle to dispose vertically with left and right clamping members fitted in a recessed portion of a fastening sleeve from both sides will align indentations of the left and right clamping members, thereby opening the lock. In the locked stated, a turning of the key causes the latch bolt mechanism to enter into one of two positions. In one position the spindle is disposed horizontally, the left and right clamping members are spaced in the recessed portion of the fastening sleeve, and the indentations of the left and right clamping members are not aligned, thereby deactivating a handle for preventing an unauthorized opening of the lock from occurring.

### FIELD OF THE INVENTION

The present invention relates to tubular locks and more particularly to a tubular lock having a two-stage latch bolt mechanism adapted to enter into one of two positions in which in one position a handle is an inoperable state for inhibiting a thief from opening the lock. The lock is further advanced for preventing a break or damage from occurring.

### DESCRIPTION OF RELATED ART

Conventionally, a lock (e.g., tubular lock) is designed to allow a user to lock a door only. However, means for inhibiting a thief from directly opening the lock or using a tool to open the lock is not provided by such lock. Unfortunately, our living environment is not improved much or even deteriorated for making the elimination of lock in our daily impossible. Thus, it is desirable to provide a novel tubular lock capable of inhibiting a thief from directly opening the lock or using a tool to open the lock.

### SUMMARY OF THE INVENTION

It is an object of the present invention to provide a tubular lock having a two-stage latch bolt mechanism in which a handle is adapted to rotate to activate the two-stage latch bolt mechanism when the lock has been opened by using a key. Also, the key may be adapted to push the two-stage latch bolt mechanism to entere into one of two positions for inhibiting the operation of the handle. As a result, an opening of the lock is prohibited. Further, a possible break or damage of the lock by force exerted by a thief is substantially prevented.

It will be evident that the present invention has the following advantages: (1) Two space bars of the outside knob are driven through the two-stage latch bolt mechanism and the inside knob for fastening them together. Hence, the inside knob turns as the outside knob turns. An elongate, flat spindle is extended from one end of the spindle unit. Hence, insert the spindle into a cam of the two-stage latch bolt mechanism and turn the spindle to dispose vertically with the left clamping member and the right clamping member fitted in the recessed portion of the fastening sleeve from both sides. Also, indentations of the left clamping member and the right clamping member are aligned each other. Thus, a handle is adapted to rotate downwardly to open the two-stage latch bolt mechanism. (2) In a locked position of the door a turning of a key may cause the two-stage latch bolt mechanism to enter into one of two positions in which in one position the spindle is disposed horizontally, the left clamping member and the right clamping member are spaced in the recessed portion of the fastening sleeve, and the indentations of the left clamping member and the right clamping member are not aligned each other. Thus, the handle enters into an inoperable state. As a result, an opening of the lock is prohibited. Further, a possible break or damage of the lock by force exerted by a thief is substantially prevented.

The above and other objects, features and advantages of the present invention will become apparent from the following detailed description taken with the accompanying drawings.

### BRIEF DESCRIPTION OF THE DRAWINGS

FIG. 1 is an exploded view of the inside knob of a tubular lock according to the invention;

FIG. 2 is an exploded view of the outside knob of the tubular lock;

FIG. 3 is an exploded view of the two-stage latch bolt mechanism of the tubular lock;

FIG. 4 is an exploded perspective view showing the tubular lock to be assembled;

FIG. 5 is a cross-sectional view of the assembled inside knob;

FIG. 6 is a cross-sectional view of the assembled outside knob;

FIG. 7 is a front plan view of the outside knob of the opened lock, where the left clamping member and the right clamping member are aligned in the indentations by turning the spindle unit;

FIG. 8 is a rear plan view of the inside knob of the opened lock, where the follower is rotating;

FIG. 9 is a view similar to FIG. 7, where the left clamping member and the right clamping member are not aligned in the indentations by turning the spindle unit, and the handle is in an inoperable state;

FIG. 10 is a view similar to FIG. 8, where the follower is held in place without rotation;

FIG. 11 is a front plan view in part section of the outside knob of the opened lock, where a change of the handle is allowed; and

FIG. 12 is a view similar to FIG. 11, where a change of the handle is prohibited.

### DETAILED DESCRIPTION OF THE PREFERRED EMBODIMENTS

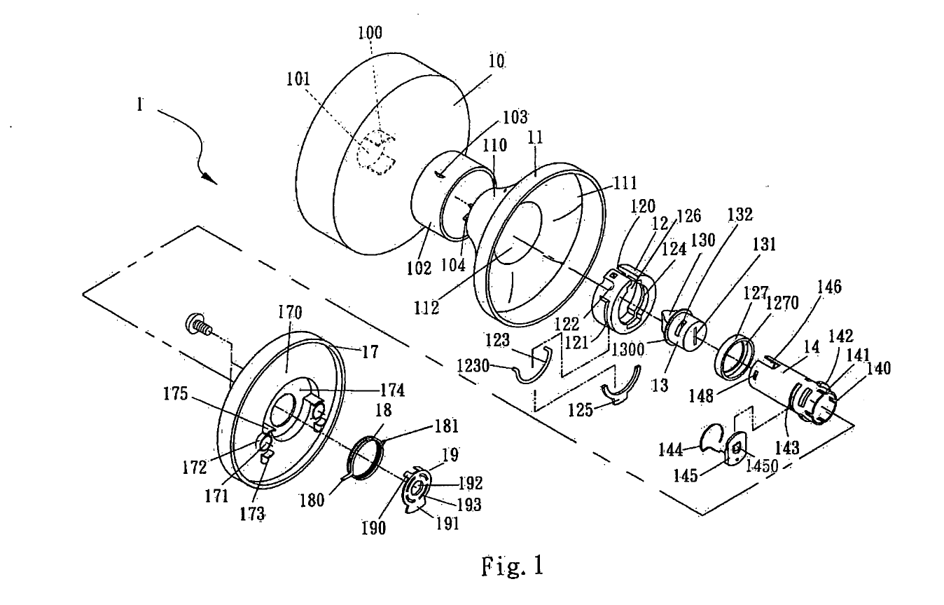

Referring to FIGS. 1 to 3, there is shown a tubular lock constructed in accordance with the invention. The lock comprises an inside knob 1, an outside knob 2, and a two-stage latch bolt mechanism 3 interconnecting the inside knob 1 and the outside knob 2.

The inside knob 1 comprises a knob member 10, a shroud 11, a fastening sleeve 12, a rotation cylinder 13, an abutment member 14, a cap 17, a spring 18, and a follower 19. Each component will be described in detail below.

The knob member 10 comprises a central aperture 101 at a front side, two opposite protuberances 100 in an interior wall of the central aperture 101, a hollow shell 102 at the rear, a dent 103 on the shell 102, and an arcuate slit 104 in the shell 102. The shroud 11 comprises a front bell 110 fitted on the shell 102 of the knob member 10, a recessed portion 111 at the rear with the cap 17 fitted thereon, and a central cavity 112. The fastening sleeve 12 is put on the shell 102 of the knob member 10 and comprises an axial gap 120, a well 122 adjacent the gap 120, an arcuate groove 121, a C-shaped clip 123 having two bent ends 1230 received in the arcuate groove 121, an arcuate member 125 put on the clip 123 for anchoring in the arcuate slit 104 in the shell 102, a central bore 126, an arcuate trough 124 in an interior wall, and a rear ring 127 having an interior, peripheral recess 1270. The rotation cylinder 13 comprises a front pivot 130 having an annular flange 1300, a rear slit 131, and a triangular well 132 on a surface. The rotation cylinder 13 is received in the central aperture 101 of the knob member 10 and is urged against the flange 130.

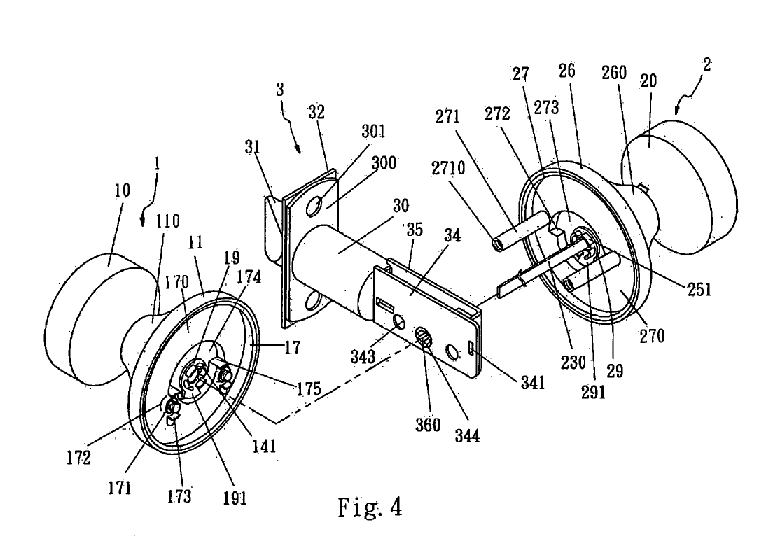

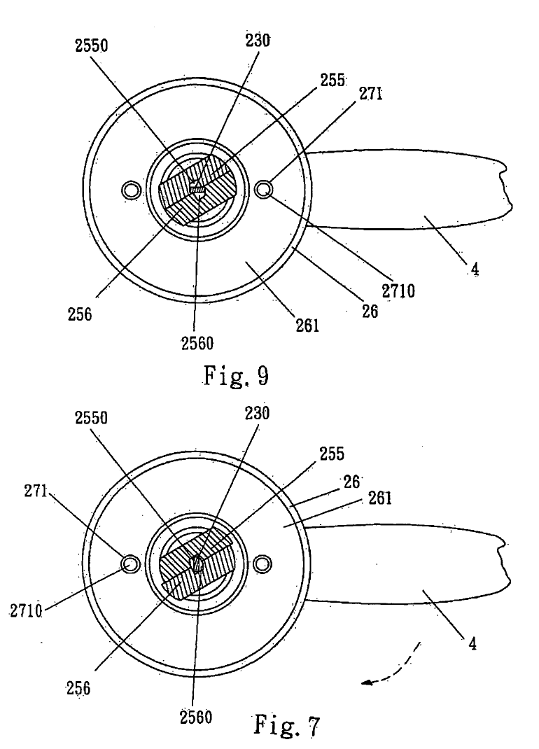

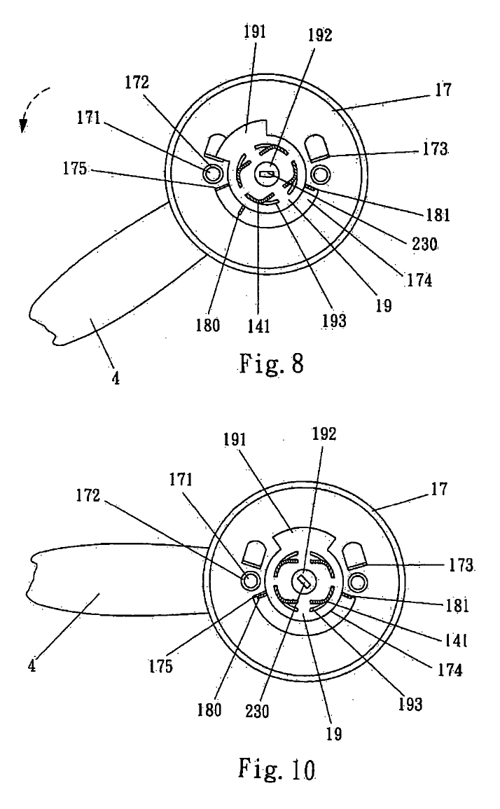

The abutment member 14 is a hollow, cylindrical member and comprises a rear projection 141, four gaps 140 equally spaced around the projection 141, two opposite protrusions 142 adjacent the projection 141, the protrusions 142 being fitted in the ring 127 and being stopped by the peripheral recess 1270, an arcuate groove 143, a snapping member 145 having a central opening 1450, a C-shaped clip 144 fastened on the snapping member 145 prior to fitting in the arcuate groove 143, a peripheral, elongate opening 146 extended from the front end for matingly engaging with the protuberance 100 of the knob member 10, and a slit 148 adjacent the peripheral opening 146, the slit 148 being aligned with the triangular well 132 of the rotation cylinder 13. The cap 17 comprises a recessed portion 170 around a central opening, two spaced bosses 172 having a hole 171, two studs 173 each below the boss 172, an arcuate shoulder 175 interconnecting the bosses 172, and a space 174 further recessed within the recessed portion 170. The spring 18 comprises two ends 180, 181 fastened in the space 174. The follower 19 comprises two top legs 190 pressed on the spring 18, a bottom protruding sector 191, a central opening 192, and a plurality of equally spaced arcuate channels 193 around the opening 192 for permitting the projection 141 of the abutment member 14 to insert as detailed later. Referring to FIGS. 4, 5, and 8 in conjunction with FIG. 1, an assembly of the inside knob 1 will now be described in detail below. Put the shroud 11 on the shell 102 of the knob member 10. Next, insert the fastening sleeve 12 into the central cavity 112 of the shroud 11 with the rotation cylinder 13 fastened in the fastening sleeve 12. Next, put the ring 127 on the abutment member 14 with the protrusions 142 being stopped by the peripheral recess 1270 of the ring 127. Next, insert the ring 127 and the abutment member 14 into the bore 126 of the fastening sleeve 12. Next, snap the cap 17 in the recessed portion 111 of the shroud 11. Next, put the spring 18 on the abutment member 14 and insert the projection 141 through the channels 193 of the follower 19. Finally, slightly bend the projected portions of the projection 141 for fastening the follower 19.

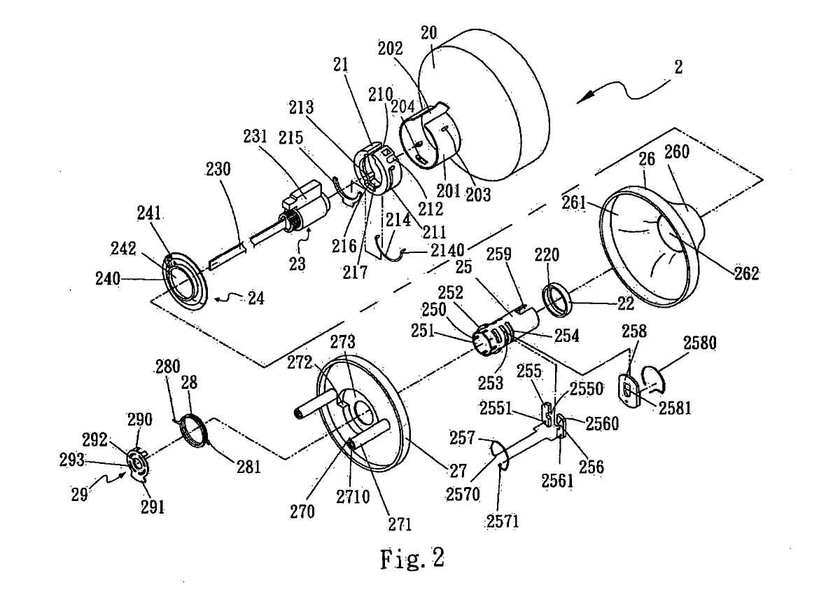

Referring to FIG. 2 specifically, the outside knob 2 comprises a knob member 20, a fastening sleeve 21, a ring 22, a spindle unit 23, a bushing 24, an abutment member 25, a shroud 26, a cap 27, a spring 28, and a follower 29. Each component will be described in detail below.

The knob member 20 comprises a front, hollow shell 201, a peripheral, elongate opening 202, a dent 203 on the shell 201, and an arcuate slit 204 in the shell 201. The fastening sleeve 21 is put on the shell 201 of the knob member 20 and comprises an axial gap 210, a well 212 adjacent the gap 210, an arcuate groove 211, a C-shaped clip 214 having two bent ends 2140 received in the arcuate groove 211, an arcuate member 215 put on the clip 214 for anchoring in the arcuate slit 204 on the shell 201, a central bore 216, a recessed portion 217 on the edge of the bore 216, and an arcuate trough 213 in an interior wall. The spindle unit 23 comprises an elongate, flat spindle 230 inserted through the two-stage latch bolt mechanism 3 into the rear slit 131 of the rotation cylinder 13, and a top ridge 231 for matingly engaged with a peripheral, elongate opening 259 of the abutment member 25 as detailed later. The bushing 24 comprises an annular flange 240 in the front, a ring 241, and a central opening 242 put on the shell 201 of the knob member 20. The ring 22 has an interior, peripheral recess 220.

The abutment member 25 is a hollow, cylindrical member and comprises a front projection 251, four gaps 250 equally spaced around the projection 251, two opposite protrusions 252 adjacent the projection 251, the protrusions 252 being stopped by the peripheral recess 220 of the ring 22, an arcuate first groove 253, an arcuate second groove 254, a left clamping member 255 including an indentation 2550 and a lower hole 2551, a right clamping member 256 including an indentation 2560 and a lower hole 2561, the left clamping member 255 and the right clamping member 256 being fitted in the second groove 254, a C-shaped clip 257 having two ends 2570, 2571 fastened in the holes 2251, 2261 respectively, a snapping member 258 having a central opening 2581 and a C-shaped clip 2580 fastened in the first groove 253, and a peripheral opening 259 extended from the rear end for matingly engaging with the ridge 231 of the spindle unit 23. The shroud 26 comprises a rear bell 260 fitted on the shell 201 of the knob member 20, a recessed portion 261 at the front with the cap 27 fitted thereon, and a central cavity 262. The cap 27 comprises a recessed portion 270 around a central opening, two spaced bars 271 having a threaded hole 2710 for threadedly coupling to the bosses 172 of the cap 17, a space 273 further recessed within the recessed portion 270, and an arcuate shoulder 272 on the edge of the space 273. The spring 28 comprises two ends 280, 281 fastened in the space 273 of the cap 27. The follower 29 comprises two top legs 290 pressed on the spring 28, a bottom protruding sector 291, a central opening 292, and a plurality of equally spaced arcuate channels 293 around the opening 292 for permitting the projection 251 of the abutment member 25 to insert prior to bending for fastening.

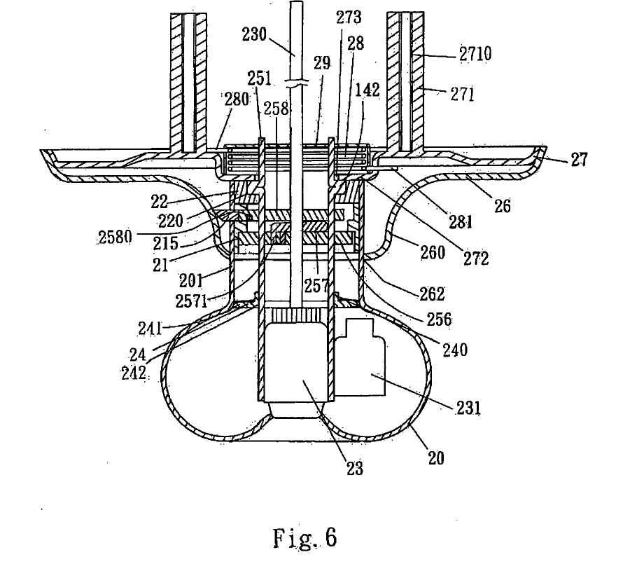

Referring to FIGS. 4 and 6 in conjunction with FIG. 2, an assembly of the outside knob 2 will now be described in detail below. Put the shell 201 of the knob member 20 on the fastening sleeve 21. Next, insert the spindle unit 23 into the fastening sleeve 21. Next, put the bushing 24 on the spindle unit 23. Next, put the ring 22 on the abutment member 25 with the protrusions 252 being stopped by the peripheral recess 220 of the ring 22. Next, insert the ring 22 and the abutment member 25 into the cavity 262 of the shroud 26. Next, insert the projection 251 of the abutment member 25 into the cap 27 prior to fitting the cap 27 in the recessed portion 261 of the shroud 26. Next, put the spring 28 on the abutment member 25 and insert the projection 251 through the channels 293 of the follower 29. Finally, slightly bend the projected portions of the projection 251 for fastening the follower 29.

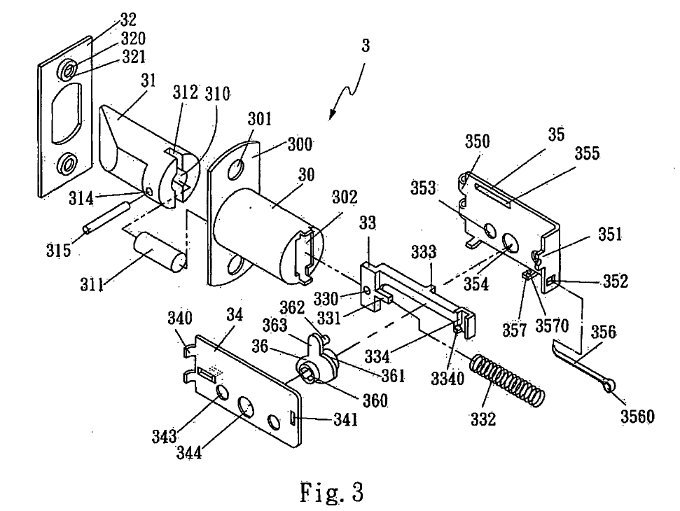

Referring to FIG. 3 specifically, the two-stage latch bolt mechanism 3 comprises a lock housing 30, a latch bolt 31, a second faceplate 32, an abutment member 33, a left board 34, a right board 35, and a cam 36. Each component will be described in detail below.

The lock housing 30 comprises a first faceplate 300 having upper and lower holes 301, and a rear opening 302. The latch bolt 31 is partially received in the lock housing 30. The latch bolt 31 comprises an axial, central hole 310, a cylinder 311 received in the hole 310, a slit 312 passed the hole 310 and being perpendicular thereto, and a lateral aperture 314 through the hole 310. The second faceplate 32 comprises upper and lower bosses 321 having a hole 320, the bosses 321 being adapted to matingly engage with the holes 301 for fastening the second faceplate 32 and the lock housing 30 together. The abutment member 33 has its front end fitted in the slit 312 of the lock housing 30 and comprises a front aperture 330 for permitting a pin 315 passing the lateral aperture 314 to insert through for fastening the abutment member 33, a rearwardly projecting stud 331 adjacent the front aperture 330, a spring 332 put on the stud 331, a peg 333 at the right side being adapted to slide in a slit 335 of the right board 35 as detailed later, and a rear, longitudinal tunnel 334 having a half-circular recess 3340, the tunnel 334 being adapted to permit a pin 362 of the cam 36 to fit therein for locking or unlocking the latch bolt 31 and fastening the locked latch bolt 31.

The rectangular left board 34 comprises two side hooks 340 fastened at one side of the rear opening 302 of the lock housing 30, a rear slit 341, two first holes 343, a second hole 344 between the first holes 343 for permitting a peripheral member 361 of the cam 36 to fit therein, and a receptacle (not numbered) adjacent the hooks 340 for anchoring the other end of the spring 332. The rectangular right board 35 comprises two side hooks 350 fastened at the other side of the rear opening 302 of the lock housing 30, a stud 351 at a rear side fitted in the rear slit 341, an opening 352 below the stud 351, a pin 356 having a hooked head 3561, the pin 356 being adapted to fasten in the opening 352, two first holes 353, a second hole 354 between the first holes 353 for permitting the peripheral member 361 of the cam 36 to fit therein, a slit 335 near a top side for permitting the peg 333 to slide therein, and a tab 357 having an indentation 3570 below the right one of the first holes 353, the indentation 3570 being adapted to permit the hooked head 3561 to fasten therein. The cam 36 comprises a crossmember 360, a peripheral member 361 fitted in the second holes 344, 354 of the left board 34, the right board 35 so that a fastener (e.g., bolt) can be driven through the first holes 343, 353 for fastening the left board 34, the right board 35 together, and a protruding actuator 363 having a pin 362 fitted in the longitudinal tunnel 334.

Referring to FIG. 4 specifically, an assembly of the tubular lock of the invention will now be described in detail below. Insert the bars 271 of the cap 27 of the outside knob 2 through the first holes 343, 353 of the left board 34, the right board 35 of the two-stage latch bolt mechanism 3. Next, further insert the bars 271 of the cap 27 for engaging with the bosses 172 prior to fastening by bolts.

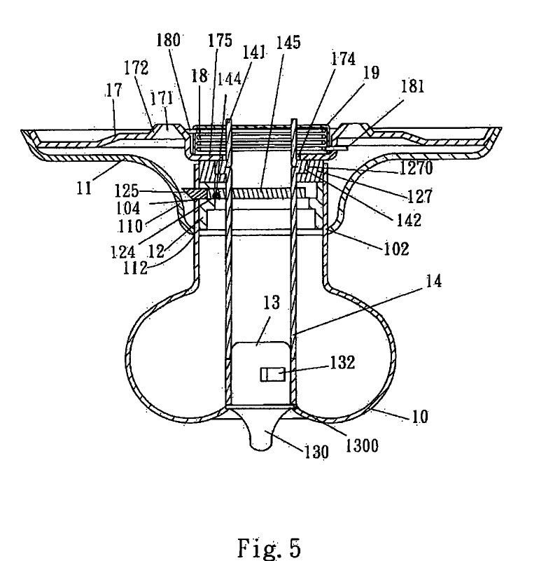

Referring to FIGS. 5, 6, 7, and 8, an operation of the tubular lock of the invention will now be described in detail below. Insert a key into a keyhole. Next, turn the key to cause the spindle 230 of the spindle unit 23 to insert into the crossmember 360 of the cam 36 of the two-stage latch bolt mechanism 3 until the spindle 230 inserts into the rear slit 131 of the rotation cylinder 13. For opening the lock, turn the spindle 230 to dispose vertically with the left clamping member 255 and the right clamping member 256 fitted in the recessed portion 217 of the fastening sleeve 21 from both sides. Also, the indentations 2550, 2560 of the left clamping member 255 and the right clamping member 256 are aligned each other. At the moment, a handle 4 is adapted to rotate downwardly to open the two-stage latch bolt mechanism 3. Also, the inside knob 1 is rotated to dispose in the space 174 of the cap 17. The sector 191 of the follower 19 is biased to the left by the spring 18 for urging the studs 173. As a result, the door is opened.

Referring to FIGS. 9 and 10, in a locked position of the door a turning of the key may cause the two-stage latch bolt mechanism 3 to enter into one of two positions in which in one position the spindle 230 is disposed horizontally, the left clamping member 255 and the right clamping member 256 are spaced in the recessed portion 217 of the fastening sleeve 21, and the indentations 2550, 2560 of the left clamping member 255 and the right clamping member 256 are not aligned each other. At the moment, the handle 4 enters into an inoperable state. As a result, an opening of the lock is prohibited. Further, a possible break or damage of the lock by force exerted by a thief is substantially prevented.

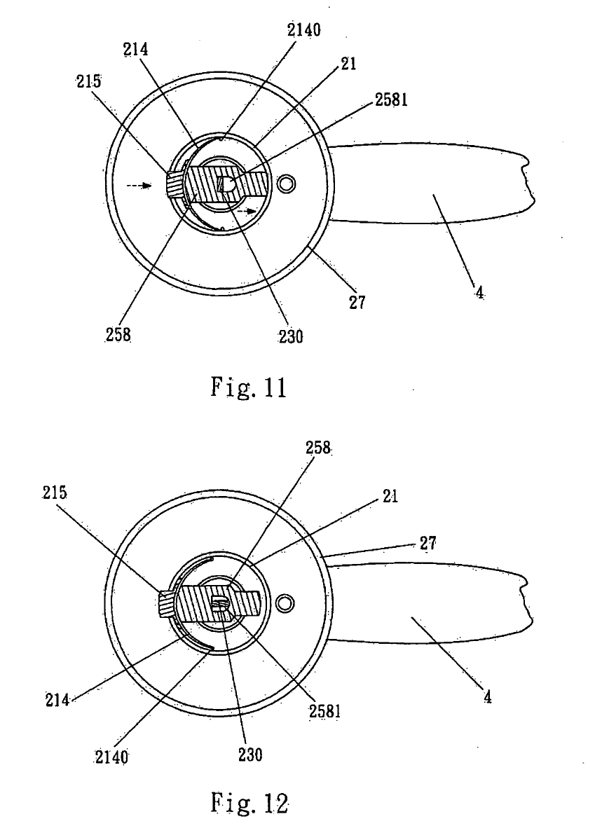

Referring to FIG. 11, there is shown a front plan view in part section of the outside knob 2 of the opened lock. The snapping member 258 of the abutment member 25 in the arcuate first groove 253 contacts both the clip 214 of the fastening sleeve 21 in the arcuate trough 213 and the arcuate member 215. At the same time, the snapping member 258 moves to the right for locking the spindle 230 at the side of the central opening 2581. At this moment, a change of the handle 4 is allowed.

Referring to FIG. 12, there is shown a rear plan view of the inside knob 1 of the opened lock. The snapping member 258 of the abutment member 25 in the arcuate first groove 253 contacts the clip 214 of the fastening sleeve 21 in the arcuate trough 213. The arcuate member 215 projected into the arcuate trough 213 and the snapping member 258 do not move to the right. As such, the horizontally disposed spindle 230 is still positioned in the central opening 2581 of the snapping member 258. At this moment, a change of the handle 4 is prohibited.

While the invention herein disclosed has been described by means of specific embodiments, numerous modifications and variations could be made thereto by those skilled in the art without departing from the scope and spirit of the invention set forth in the claims.

What is claimed is:

1. A tubular lock comprising an inside knob, an outside knob, and a two-stage latch bolt mechanism interconnecting the inside knob and the outside knob, wherein:
the two-stage latch bolt mechanism comprises a lock housing, a latch bolt, a second faceplate, an abutment element, a left board, a right board, and a cam;
the inside knob comprises a first knob member, a first shroud, a first fastening sleeve, a rotation cylinder, an first abutment member, a first cap, a first spring, and a first follower, wherein:
the first knob member comprises a front central aperture, two opposite protuberances in an interior wall of the central aperture, a rear hollow first shell, a dent on the first shell, and an arcuate slit in the first shell;
the first shroud comprises a front bell fitted on the first shell, a rear recessed portion with the first cap fitted thereon, and a central cavity;
the first fastening sleeve is put on the first shell and comprises an axial gap, a well adjacent the axial gap, an arcuate first groove, a C-shaped first clip having two bent ends received in the arcuate first groove, an arcuate member put on the first clip for anchoring in the arcuate slit of the first knob member in the first shell, a central bore, an arcuate trough in an interior wall, and a rear ring having an interior, peripheral recess;
the rotation cylinder comprises a front pivot having an annular flange, a rear slit, and a triangular well on a surface, the rotation cylinder being received in the central aperture of the first knob member and being urged against the annular flange of the rotation cylinder;
the first abutment member is a hollow cylinder and comprises a rear projection, four gaps equally spaced around the rear projection, two opposite protrusions adjacent the rear projection, the protrusions being fitted in the rear ring and being stopped by the peripheral recess of the rear ring, an arcuate second groove, a snapping member having a central opening, a C-shaped second clip fastened on the snapping member prior to fitting in the arcuate second groove, a peripheral, elongate opening extended from the front end for matingly engaging with the protuberance of the first knob member, and a slit adjacent the elongate opening, the slit being aligned with the triangular well;
the first cap comprises a recessed portion around a central opening, two spaced bosses having a hole, two studs each below the boss, an arcuate shoulder interconnecting the bosses, and a first space further recessed within the recessed portion;
the first spring comprises two ends fastened in the first space; and
the first follower comprises two top legs pressed on the first spring, a bottom protruding sector, a central opening, and a plurality of equally spaced arcuate channels around the opening for permitting the rear projection of the first abutment member to insert so that put the first shroud on the first shell, insert the first fastening sleeve into the central cavity of the first shroud with the rotation cylinder fastened in the first fastening sleeve, put the rear ring on the first abutment member with the protrusions of the first abutment member being stopped by the peripheral recess of the rear ring, insert the rear ring and the first abutment member into the central bore of the first fastening sleeve, snap the first cap in the recessed portion of the first shroud, put the first spring on the first abutment member and insert the rear projection of the first abutment member through the channels of the first follower, and bend projected portions of the rear projection of the first abutment member for fastening the first follower; and
the outside knob comprises a second knob member, a second fastening sleeve, a ring element, a spindle unit, a bushing, an second abutment member, a second shroud, a second cap, a second spring, and a second follower, wherein
the second knob member comprises a front, hollow second shell, a peripheral, elongate opening, a dent on the second shell, and an arcuate slit in the second shell;
the second fastening sleeve is put on the second shell and comprises an axial gap, a well adjacent the axial gap thereof, an arcuate third groove, a C-shaped third clip having two bent ends received in the arcuate third groove, an arcuate member put on the third clip for anchoring in the arcuate slit of the second knob member on the second shell, a central bore, a recessed portion on the edge of the central bore of the second fastening sleeve, and an arcuate trough in an interior wall;
the spindle unit comprises an elongate, flat spindle inserted through the two-stage latch bolt mechanism into the rear slit of the rotation cylinder, and a top ridge;
the bushing comprises a front annular flange, a ring, and a central opening put on the second shell;
the ring element includes an interior, peripheral recess;
the second abutment member is a hollow cylinder and comprises a front projection, four gaps equally spaced around the front projection, two opposite protrusions adjacent the front projection, the protrusions being stopped by the peripheral recess of the ring element, an arcuate first furrow, an arcuate second furrow, a left clamping member including an indentation and a lower hole, a right clamping member including an indentation and a lower hole, the left clamping member and the right clamping member being fitted in the second furrow, a C-shaped fourth clip having two ends fastened in the holes of the left and right clamping members respectively, a snapping member having a central opening and a C-shaped fifth clip fastened in the first furrow, and a peripheral opening extended from the rear end for matingly engaging with the ridge;
the second shroud comprises a rear bell fitted on the second shell, a front recessed portion with the second cap fitted thereon, and a central cavity;
the second cap comprises a recessed portion around a central opening thereof, two spaced bars having a threaded hole for threadedly coupling to the bosses of the first cap, a second space further recessed within the recessed portion thereof, and an arcuate shoulder on the edge of the second space;
the second spring comprises two ends fastened in the second space; and
the second follower comprises two top legs pressed on the second spring, a bottom protruding sector, a central opening, and a plurality of equally spaced arcuate channels around the central opening thereof for permitting the front projection to insert prior to bending for fastening so that put the second shell on the second fastening sleeve, insert the spindle unit into the second fastening sleeve, put the bushing on the spindle unit, put the ring element on the second abutment member with the protrusions of the second abutment member being stopped by the peripheral recess of the ring element, insert the ring element and the second abutment member into the central cavity of the second shroud, insert the front projection into the second cap prior to fitting the second cap in the recessed portion of the second shroud, put the second spring on the second abutment member, insert the front projection through the channels of the second follower, and bend projected portions of the front projection for fastening the second follower;
wherein use a key to insert the spindle into the cam, turn the spindle to dispose vertically with the left and right clamping members fitted in the recessed portion of the second fastening sleeve from both sides, and the indentations of the left and right clamping members are aligned each other, thereby opening the lock; and in the locked stated of the lock, a turning of a key causes the two-stage latch bolt mechanism to enter into one of two positions wherein in one position the spindle is disposed horizontally, the left and right clamping members are spaced in the recessed portion of the second fastening sleeve, and the indentations of the left and right clamping members are not aligned each other, thereby causing a handle to enter into an inoperable state for preventing an unauthorized opening of the lock from occurring by force.

2. The tubular lock of claim 1, wherein the abutment element comprises a rear, longitudinal tunnel having a half-circular recess.

3. The tubular lock of claim 1, wherein the right board comprises a rear stud having a lower opening.

4. The tubular lock of claim 1, wherein the right board further comprises a lower tab having an indentation.
